(19) United States
(12) Patent Application Publication
(10) Pub. No.: US 2008/0119340 A1
(43) Pub. Date: May 22, 2008

(54) Rotary Bag Machine

(75) Inventors: Paul Selle, Appleton, WI (US); Paul Johnson, Menasha, WI (US); Mike Stickney, Appleton, WI (US); Gregory J. Nackers, Pulaski, WI (US)

Correspondence Address: GEORGE R CORRIGAN, 5 BRIARCLIFF COURT, APPLETON, WI, 54915, US

(73) Assignee: CMD Corporation, Appleton, WI (US)

(21) Appl. No.: 11/665,705

(22) PCT Filed: Oct. 13, 2005
(86) PCT No.: PCT/US05/36677

§ 371 Date: Apr. 17, 2007

Related U.S. Application Data
(63) Continuation-in-part of application No. 10/969,332, filed on Oct. 19, 2004, now abandoned.

(51) Int. Cl. B31B 1/64; B31B 1/74; B31B 1/94; B31B 1/10; B31B 41/02; B31B 41/60

(52) U.S. Cl. 493/11; 493/193; 493/8

(57) ABSTRACT

A rotary bag machine and method for making bags from a film are disclosed. They include a rotary drum, an accumulation nip, a blanket that positions the film against the drum, and a blanket tensioner located away from the accumulation nip. The drum includes at least one seal bar mounted thereon, and the accumulation nip provides the film to the drum. Various aspects include the accumulation nip being in a fixed position independent of changes of the drum diameter, and/or the path from the accumulation nip to the drum being fixed in length, independent of changes of the drum diameter. An accumulation sensor and a controller that controls the accumulation nip speed and the drum speed in response to the sensor are provided in one embodiment. The speed control is in response to the speed of the film, the rate of change of a function of the input, response history, and/or a setpoint, in various alternatives. A drawtape module and a powered unwind are disposed in a single module with the rotary drum, in another embodiment. A registration mark sensor is located upstream of the accumulation nip, along a path having a fixed length to the drum, in another embodiment. The sensor may be a print sensor.

### FIELD OF THE INVENTION

The present invention relates generally to the art of bag malting. More specifically, it relates to rotary bag machines, and bags made thereon.

### BACKGROUND OF THE INVENTION

Rotary bag machines are well known in the art. Prior art rotary bag machines are described in, for example, U.S. Pat. Nos. 6,117,058; 5,587,032; 5,518,559; 4,642,084; and 4,934,993, all of which are hereby incorporated by reference.

Generally, a rotary bag machine includes an infeed section, a rotary drum, and downstream processing modules. The infeed section provides film to the rotary drum at a desired speed. The rotary drum has one or more seal bar mounted thereon. The film is held to the drum by a blanket under tension, and the seal bar seals the film, thereby creating bags between successive seals. The number of the seal bars and the drum diameter determine the distance between seals, which is the bag length, To adjust the bag length different number of seal bars on the drum are activated, and/or the drum diameter is changed to adjust the distance between seals.

Prior art rotary bag machines used a lay-on roll as part of the seal blanket tensioning device, such as rolls whose position controls the tension of the blanket and the blanket path. (The lay-on roll may also be called an accumulation nip because excess film accumulates after the nip). The lay-on roll adjusted the blanket tension to insure proper seals were made. However, the nip position changed with a change in drum size or diameter (to make different bag lengths). The nip position changing resulted in a change in the amount of film accumulation (accumulating film means the excess film provided that results in the film not being flush with the surface), and required the lay-on roll to be re-adjusted. Moreover, the lay-on nip wrap position had to be manually adjusted. This made it difficult to adjust bag length. This also changed the path length from anything upstream, such as a registration mark sensor, to the drum (or the location where the film reached the seal bar and was sealed).

Typically rotary bag machines have modules for various processing functions (such as inserting a drawtape, unwinding, perforating, etc). The modules were in separate housings, which makes the line of equipment flexible and versatile for different needs, and allows sections to be moved around easily. However, each module was an independent self contained machine, and included its own controller and increased the cost and complexity of the line. It also increases the number of tension zones and requires a very long web path, which can have an adverse effect on the process.

Prior art rotary bag adjust web tension prior to the sealing drum, to attempt to insure there is no tension in the film while it is being sealed. This usually means the film has excess accumulation since it is a difficult to provide no tension without excess accumulation. The adjustment is done by an operator visually watching while the lay-on roll is adjusted back and forth until the desired amount of accumulation is seen. The accumulation bubble is often sucked into the sealing drum between sealing bars in an irregular fashion.

The inconsistent tension and accumulation bubble before and after the sealing drum can cause a number of process problems, including causing the seals to not being where they are expected to be for downstream processing, such as when the perforation knife makes a cut.

Accordingly, a rotary bag machine that provides a consistent accumulation is desired. The accumulation nip location should not change when the drum diameter is adjusted, nor should the path length from the accumulation nip (and upstream locations) to the location where the seal is begun to be made.

### SUMMARY OF THE PRESENT INVENTION

According to a first aspect of the invention a rotary bag machine and method for making bags from a film include a rotary drum, an accumulation nip, a blanket that positions the film against the drum, and a blanket tensioner located away from the accumulation nip. The drum includes at least one seal bar mounted thereon, and the accumulation nip provides the film to the drum.

According to a second aspect of the invention a rotary bag machine and method for making bags from a film include a rotary drum, an accumulation nip, and a blanket that positions the film against the drum. The drum has an adjustable diameter and includes at least one seal bar mounted thereon, and the accumulation nip provides the film to the drum. The accumulation nip is in a fixed position independent of changes of the drum diameter.

According to a third aspect of the invention a rotary bag machine and method for making bags from a film include a rotary drum, an accumulation nip, a blanket that positions the film against the drum, and an accumulation sensor. The drum includes at least one seal bar mounted thereon, and the accumulation nip provides the film to the drum. The accumulation nip is driven at a first speed and the drum is driven at a second speed controlled in response to the sensor.

According to a second aspect of the invention a rotary bag machine and method for making bags from a film include a rotary drum, an accumulation nip, and a blanket that positions the film against the drum. The drum has an adjustable diameter and includes at least one seal bar mounted thereon, and the accumulation nip provides the film to the drum. The film follows a path from the accumulation nip to the drum, wherein the path length does not change in response to changes of the drum diameter.

A drawtape module and a powered unwind are disposed in a single module with the rotary drum, in an alternative embodiment.

A registration mark sensor is located upstream of the accumulation nip, along a path having a fixed length to the drum, in another embodiment. The sensor may be a print sensor.

The speed control is in response to the speed of the film, the rate of change of a function of the input, response history, and/or a setpoint, in various alternatives.

Other principal features and advantages of the invention will become apparent to those skilled in the art upon review of the following drawings, the detailed description and the appended claims.

### BRIEF DESCRIPTION OF THE DRAWINGS

FIG. 1 is schematic of one embodiment of the present invention.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular rotary bag machine, it should be understood at the outset that the invention may also be implemented with other bag machines or in other environments.

Generally, the invention provides for controlling the accumulation of film as it reaches the drum. This allows for better control of the process, yet still provides for sealing under no or little tension. In one embodiment the seals are made under little or no tension by statically pinning the film to the blanket before and after a seal location.

The accumulation is controlled, preferably, by separating the blanket tensioner from the accumulation nip. Thus, adjusting blanket tension (necessary after the drum diameter is adjusted), does not change the location of the accumulation nip. Fixing the accumulation nip allows the seals to be more precisely located, thus the usefulness of an upstream registration mark sensor will be enhanced.

The preferred embodiment provides for sensing and controlling the accumulation nip and the drum speed (or diameter) with servo motors. The relative speeds (or electronic gear ratio), is preferably controlled using feedback from an accumulation sensor (a sensor that senses the amount of accumulated film).

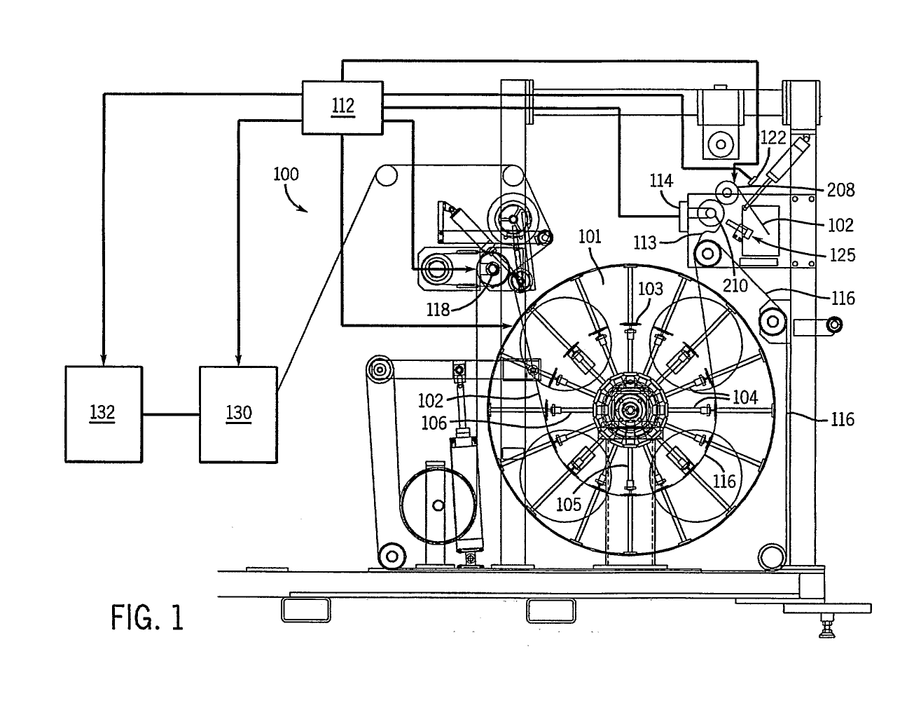

Referring now to FIG. 1, a rotary bag machine 100 in accordance with the preferred embodiment is shown to include a rotary drum 101 to seal a film 102 with four seal bars 103-106 mounted thereon. More or fewer seal bars may be used in other embodiments, and not all are necessarily activated, depending on the bag length. Drum 101 preferably has an adjustable diameter “D”.

An accumulation nip is provided between rolls 108 and 110. One or both of these rolls is driven at a speed controlled by a controller 112 (indicated by the arrow from controller 112 to roll 110) as set forth below. The film is accumulated at the drum in a “bubble” (see, as an example, 113). The amount of accumulation is sensed by an accumulation sensor 114. Sensor 114 is preferable an off the shelf analog ultrasound sensor that senses the amount of the accumulation.

A blanket 116 is provided to help hold the film against the seal bars. Blanket 116 is tensioned by roll 118 (whose position may be adjustable). Alternatives provide for the tension to be provided elsewhere, but preferably not at accumulation nip 108/110 so that the changes in tension do not change the position of nip 108/110. The film contacts drum 101 at a location 120. When a seal bar is at location 120 the film begins to seal at that location, and the seal is completed as drum 101 rotates with the film such that the seal bar maintains contact which the film at a given location.

Drum 101 is also servo driven, and controller 112 sets the speed of the accumulation nip 108/110 relative to drum 101 to maintain the desired accumulation. To increase the amount of film accumulated, the speed of nip 108/110 is increased, and to decrease the accumulation the speed of nip 108/110 is decreased by controller 112, in response to sensor 114. The accumulation is provided so that the film, particularly thinner film, doesn't tear as easily, and helps with registration control, as described below.

Controller 112 may use any control scheme that works, but the preferred embodiment calls for the controller to control in response to the sensed accumulation filtered, the speed of the machine, the rate of change speed (or accumulation), the history or past values of the control, and a set point. (In response to, as used herein, means dependent on the value directly, or dependent on a function of the value, such as an average, differential, product, scaling, integral, etc.). Alternatives do not provide automatic control, or allows the user to disable automatic control.

The preferred embodiment provides filtering to smooth out the sensor reading, speed control based on the web displacement, four speed ranges, eight web set points within a speed range, converging logic to stabilize speed around the set point, logic to check for range limits, self-adjusting speed ranges to optimize the set points to the response of the web, and archival of the speed ranges and set points to maintain them on power down.

More specifically, base speeds and drive ratios (for nip 108/110 to drum 101) are defined for the initial startup of the closed loop control. As each speed range is entered during the running of the machine, the base values for that range are selected. As the machine runs, the web sensor is, sampled every 250 msec. Based on the sensor reading, a drive ratio is selected to add, subtract or maintain the position of the web. The trend of the web movement is also monitored to determine if it the accumulation is growing or shrinking. Every 10 seconds the overall loop is checked to see if the web is approaching the desired set point.

In response, controller 112 can adjust the drive ratio (relative speeds) of nip 108/110 and drum 101, preferably in small increments to fine tune the set point values until a stable ratio is achieved that keeps the web in fixed position. The amount of adjustment is varied according to how close the web position is to the target. The farther off the target, the greater the increments to bring it back.

Also, the ratio range is adjusted in small increments to provide an overall range that is centered around the desired set point. This occurs as the operator moves the set point. The web position and ratio range are monitored. If the web position reaches a limit and cannot reach the set point, the entire control loop is shifted and re-initialized. This can occur if the web characteristics change.

The result is a more consistent tension by flushing a small accumulation bubble through the drum and shill roll for each bag rather than letting chance flush through a large bubble every few bags.

The preferred embodiment also provides for using a registration mark sensor 122 upstream of drum 101, and preferably upstream of nip 108/110. The sensor may be an optical or acoustical sensor that senses print, marks in the bag, regular perturbations in the film edge, or any other registration mark. Because nip 108/110 is fixed, and the amount of accumulated film 113 is constant, the path length, i.e. the distance the film travels, from sensor 122 to location 120 remains constant. Given a constant distance, it is easier to control the location of the seals relative to the mark. The enhances registration both at the drum and for downstream processes. Adjusting the drum diameter or blanket tension will not affect this distance, and thus, the registration is independent of the drum diameter and blanket tension.

Also, the distance from nip 108/110 to location 120 remains constant. This means that when the user adjust the tension or the diameter, they need not adjust the accumulation because the accumulation is independent of tension and diameter.

One embodiment includes statically pinning the film to the blanket (or drum) before and after the seal bar locations, sop that the film is under no or very little tension when being sealed. Preferably the pinning is spot pinning, but it may extend across the width of the film, or partially across the film width. A static pinner 125 is activated to be in phase with the seal bars, so that it is active on the film before the seal, and after the seal. The preferred embodiment uses a Simco Brand Static Induction Pinning Power Supply designed for C.D. to rapidly turn on and off the static charging bar for each bag. Preferably, it would only produce a static charge over 1″-2″ in the Web direction as the web passes the static charging bar. The charging bar is located downstream from nip 108/110. As the film lays against the Teflon coated sealing belt the charging bar induces a static charge spot that makes the web of film adhere to the sealing belt at, that spot. The film is still allowed to float freely between spots of static. At least one spot of static pinning is desired for each bag so any downstream tension and seal location variation is consistent with respect to when the perforation knife cuts.

Another embodiment provides a reduced tension machine by including a downstream drawtape module 130 and an unwind module 132 in a single housing with a single controller, and reducing the number of tension zones (which are necessarily between separate modules. This results in a machine that is faster and easier to thread, and has fewer operator controls and fewer moving parts. An alternative is to provide separate housing, bus a single controller, and still maintain fewer tension zones.

Numerous modifications may be made to the present invention which still fall within the intended scope hereof. Thus, it should be apparent that there has been provided in accordance with the present invention a method and apparatus for a rotary bag machine that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A rotary bag machine for making bags from a film, comprising:
a rotary drum with at least one seal bar mounted thereon;
an accumulation nip disposed to provide the film to the rotary drum;
a blanket that positions the film against the drum for sealing; and
a blanket tensioner, located away from the accumulation nip.

2. The apparatus of claim 1, wherein the film follows a film path and the apparatus further comprises a drawtape module and a powered unwind disposed in a single module with the rotary drum, wherein the film path leads from the draw tape module to the powered unwind.

3. The apparatus of claim 1, wherein the drum has an adjustable diameter for different bag lengths, and the accumulation nip is in a fixed position independent of changes of the drum diameter.

4. The apparatus of claim 3, further comprising a registration mark sensor, located upstream of the accumulation nip, wherein the film follows a path having a fixed length from the sensor to the drum.

5. The apparatus of claim 4, wherein the sensor is a print sensor.

6. The apparatus of claim 1, wherein the accumulation nip is driven at a first speed and the drum is driven at a second speed, and further comprising an accumulation sensor, and a controller that receives as an input an output of the accumulation sensor and provides a control signal to control the first speed relative to the second speed in response to the input.

7. The apparatus of claim 6, wherein the controller further provides the control signal in response to the speed of the film, the rate of change of a function of the input and a setpoint.

8. The apparatus of claim 7, wherein the controller further adjusts the control signal in response to at least the history of the input and the history of the control signal.

9. The apparatus of claim 1, wherein the drum has an adjustable diameter for different bag lengths, and the film follows a path from the accumulation nip to the drum, wherein the path length does not change in response to changes of the drum diameter.

10. A rotary bag machine for making bags from a film, comprising:
drum means for imparting seals on the film;
nip means for accumulating film and for providing the film to the drum means;
blanket means for positioning the film against the drum for sealing; and
means for providing tension to the blanket, located away from the accumulation nip means.

11. The apparatus of claim 10, wherein the film follows a film path and the apparatus further comprises a drawtape module and a powered unwind disposed in a single module, wherein the film path leads from the draw tape module to the powered unwind.

12. The apparatus of claim 10, further including means for adjusting a diameter of the drum means for different bag lengths, and wherein the nip means is in a fixed position independent of changes of the diameter.

13. The apparatus of claim 12, further comprising a means for sensing a registration mark, located upstream of the accumulated film, wherein the film follows a path having a fixed length from the sensor means to the drum means, independent of the diameter.

14. The apparatus of claim 13, wherein the means for sensing is a print sensor.

15. The apparatus of claim 10, wherein the nip means is driven at a first speed and the drum means is driven at a second speed, and further comprising a means for sensing film accumulation, and a controller that receives as an input an output of the means for sensing film accumulation and provides a control signal to control the first speed relative to the second speed in response to the input.

16. The apparatus of claim 15, wherein the controller further provides the control signal in response to the speed of the film, the rate of change of a function of the input and a setpoint.

17. The apparatus of claim 16, wherein the controller further adjusts the control signal in response to at least the history of the input and the history of the control signal.

18. The apparatus of claim 10, wherein the drum means has an adjustable diameter for different bag lengths, and the film follows a path from the nip means to the drum means, wherein the path length does not change in response to changes of the diameter.

19. A method of making bags from a film, comprising:
rotating a drum with at least one seal bar mounted thereon;
feeding film to the drum;
accumulating film between an accumulation nip and the location where the sealing begins;
holding the film against the drum for sealing using a blanket; and
tensioning the blanket away from the accumulation nip.

20. The method of claim 19, further comprises providing the film to a drawtape module and a powered unwind disposed in a single module, wherein the film follows a path from the drum to the draw tape module to the powered unwind.

21. The method of claim 19, further comprising adjusting a diameter of the drum for different bag lengths, and fixing the accumulation nip in a position independent of changes of the drum diameter.

22. The method of claim 21, further comprising sensing a registration mark upstream of the accumulation nip, wherein the film follows a path having a fixed length from the sensing to the drum.

23. The method of claim 22, wherein sensor includes sensing print.

24. The method of claim 19, further comprising driving the accumulation nip at a first speed, driving the drum at a second speed, sensing the amount of film accumulated, and controlling the first and second speeds in response to sensing.

25. The method of claim 24, further controlling in response to the speed of the film, the rate of change of a function of the input and a setpoint.

26. The method of claim 25, further controlling in response to at least the history of the input and the history of the controlling.

27. The method of claim 19, further comprising adjusting a diameter of the drum for different bag lengths, and maintaining a fixed film path length from the accumulation nip to the drum.

28. A rotary bag machine for making bags from a film, comprising:
a rotary drum with at least one seal bar mounted thereon and an adjustable diameter for different bag lengths;
an accumulation nip disposed to provide the film to the rotary drum, wherein the accumulation nip is in a fixed position independent of changes of the drum diameter; and
a blanket that positions the film against the drum for sealing.

29. The apparatus of claim 28, further comprising a registration mark sensor, located upstream of the accumulation nip, wherein the film follows a path having a fixed-length from the sensor to the location where the film meets the at least one seal bar.

30. The apparatus of claim 29, wherein the sensor is a print sensor.

31. The apparatus of claim 28, wherein the accumulation nip is driven at a first speed and the drum is driven at a second speed, and fewer comprising an accumulation sensor, and a controller that receives as an input an output of the accumulation sensor and provides a control signal to control the first speed relative to the second speed in response to the input.

32. A rotary bag machine for making bags from a film, comprising:
drum means for imparting seals on the film;
means for adjusting a diameter of the drum means for different bag lengths;
nip means for accumulating film and for providing the film to the drum means, wherein the nip means is in a fixed position independent of changes of the diameter; and
blanket means for positioning the film against the drum for sealing.

33. The apparatus of claim 32, further comprising a means for sensing a registration mark, located upstream of the accumulated film, wherein the film follows a path having a fixed length from the sensor means to the drum means, independent of the diameter.

34. The apparatus of claim 33, wherein file nip means is driven at a first speed and the drum means is driven at a second speed, and further comprising a means for sensing film accumulation, and a controller that receives as an input an output of the means for sensing film accumulation and provides a control signal to control the first speed relative to the second speed in response to the input.

35. A method of making bags from a film, comprising:
rotating a drum with at least one seal bar mounted thereon;
adjusting a diameter of the drum means for different bag lengths;
feeding film to the drum;
accumulating film between an accumulation nip and the location where the sealing begins;
holding the film against the drum for sealing using a blanket; and
tensioning the blanket away from the accumulation nip.

36. The method of claim 35, further comprising sensing a registration mark upstream of the accumulation nip, wherein the film follows a path having a fixed length from the sensor to the drum.

37. A rotary bag machine for making bags from a film, comprising:
a rotary drum with at least one seal bar mounted thereon with an adjustable diameter of the drum means for different bag lengths;
an accumulation nip disposed to provide the film to the rotary drum;
a blanket that positions the film against the drum for sealing; and
a registration marks sensor, located upstream of the accumulation nip, wherein the film follows a path having a fixed length from the sensor to the location where the film meets the at least one seal bar, independent of the diameter.

38. The apparatus of claim 37, wherein the sensor is a print sensor.

39. A rotary bag machine for making bags from a film, comprising:
drum means for imparting seals on the film;
nip means for accumulating film and for providing the film to the drum means;
means for adjusting a diameter of the drum means for different bag lengths; and
means for sensing a registration mark, located upstream of the accumulated film, wherein the film follows a path having a fixed length from the sensor means to a location where the film begins to be sealed.

40. A method of making bags from a film, comprising:
rotating a drum with at least one seal bar mounted thereon;
feeding film to the drum;
accumulating film between an accumulation nip and the location where the sealing begins;
holding the film against the drum for sealing using a blanket;
adjusting a diameter of the drum for different bag lengths; and
sensing a registration mark upstream of the accumulation nip, wherein the film follows a path having a fixed length from the sensor to the location where the film meets the at least one seal bar.

41. The method of claim 40, wherein sensor includes sensing print.

42. A rotary bag machine for making bags from a film, comprising:
a rotary drum, driven at a first speed with at least one seal bar mounted thereon;
an accumulation nip, driven at a second speed, disposed to provide the film to the rotary drum;
an accumulation sensor; and
a controller that receives as an input an output of the accumulation sensor and provides a control signal to control the first speed relative to the second speed in response to the input.

43. The apparatus of claim 42, wherein the controller further provides the control signal in response to the speed of the film, the rate of change of a function of the input and a setpoint.

44. The apparatus of claim 42, wherein the controller further adjusts the control signal in response to at least the history of the input and the history of the control signal.

45. A rotary bag machine for making bags from a film, comprising:
drum means for imparting seals on the film;
nip means for accumulating film and for providing the film to the drum means;
blanket means for positioning the film against the drum for sealing;
means for driving the nip means is at a first speed;
means for driving the drum means at a second speed;
means for sensing film accumulation; and
control means for controlling the means for driving the nip and means for driving the drum in response to the means for sensing.

46. The apparatus of claim 45, wherein the control mean further controls in response to the speed of the film, the rate of change of a function of the input and a setpoint.

47. The apparatus of claim 46, wherein the control means further adjusts the control signal in response to at least the history of the input and the history of the controlling.

48. A method of making bags from a film, comprising:
rotating a drum at a first speed, with at least one seal bar mounted thereon;
feeding film to the drum;
accumulating film between an accumulation nip driven at a second speed, and the location where the sealing begins;
holding the film against the drum for sealing using a blanket; and
sensing the amount of film accumulated; and
controlling the first and second speeds in response to sensing.

49. The method of claim 48, further controlling in response to the speed of the film, the rate of change of a function of the input and a setpoint.

50. The method of claim 49, further controlling in response to at least the history of the input and the history of the controlling.

51. A rotary bag machine for making bags from a film, comprising:
a rotary drum with an adjustable diameter for different bag lengths and at least one seal bar mounted thereon;
an accumulation nip disposed to provide the film to the rotary drum; and
a blanket that positions the film against the drum for sealing;
wherein the film follows a path from the accumulation nip to the drum and the path length does not change in response to changes of the drum diameter.

52. A rotary bag machine for making bags from a film, comprising:
drum means for imparting seals on the film;
means for adjusting a diameter of the drum mean for different bag lengths;
nip means for accumulating film and for providing the film to the drum means; and
blanket means for positioning the film against the drum for sealing;
wherein the film follows a path length from the nip means to the location where the film begins to be sealed, wherein the path length does not change in response to changes of the diameter.

53. A method of making bags from a film, comprising:
rotating a drum with at least one seal bar mounted thereon;
feeding film to the drum;
accumulating film between an accumulation nip and the location where the sealing begins; and
holding the film against the drum for sealing using a blanket; and
maintaining a fixed film path length from the accumulation nip to the location where the film meats the at least one seal bar.

54. An apparatus for making a plurality of bags from a film, comprising:
drum means for creating a plurality of successive seals on the film by activating at least one seal bar on the drum means, whereby the at least one active seal bar forms a seal on the film as the drum rotates;
means for providing the film to the drum means, disposed along a film path leading to the drum,
pinner means for statically pinning the film to a sealing blanket, disposed adjacent a film path along the drum, and;
controller means, connected to the drum means and the pinner means, for intermittently activating the pinner means in phase with the location of the seals formed on the film.

55. The apparatus of claim 54, wherein the controller means further includes means for locating the pinning at the location of the seals formed thereon.

56. The apparatus of claim 55, wherein the controller means further includes means for timing the ping such that there is a pinning time during which pinning occur, and a not-pinning time during which pinning does not occur, and wherein the pinning time is less than the not-pinning time.

57. The apparatus of claim 56, wherein the controller means further includes means for timing the pinning such that there is a pinning time during which pinning occur, and a not-pinning time during which pinning does not occur, and wherein the pinning time is less than 10% of the total of the pinning time and the not-pinning time.

58. The apparatus of claim 54, further comprising means for introducing air between the drum and the film, at locations other than where the pinning has occurred.

59. The apparatus of claim 54, wherein the film has a width and the pinning means extends the full width of the film.

60. The apparatus of claim 54, wherein the pinning means is a means for spot pinning.

61. A method of making a plurality of bags from a film, comprising,
feeding the film to a rotating drum having at least one active seal bar thereon, wherein the film follows the drum as it rotates, and whereby the at least one active seal bar forms a seal on the film as the drum rotates; and
intermittently statically pinning the film to a sealing blanket, wherein the pinning is timed to be in phase with the location of the seals formed on the film.

62. The method of claim 61, further comprising introducing an air bubble between the drum and the film, at locations other than where the pinning has occurred.

63. A method of positioning a seal on bag made using a rotary drum having at least one active seal bar thereon that forms a seal on the film as the drum rotates, thereby forming a plurality of successive seals, the improvement comprising:
intermittently statically pinning the film to a sealing blanket, wherein the pinning is timed to be in phase with the location of the seals formed on the film.
